(19) United States
(12) Patent Application Publication
(10) Pub. No.: US 2014/0331723 A1
(43) Pub. Date: Nov. 13, 2014

(54) Electronic Locking Device

(71) Applicant: Goetz-Bolko Holz, Jesus Pobre/Denia Alicante (ES)

(72) Inventor: Goetz-Bolko Holz, Jesus Pobre/Denia Alicante (ES)

(21) Appl. No.: 14/206,471

(22) Filed: Mar. 12, 2014

(30) Foreign Application Priority Data
May 8, 2013 (DE) 202013101990.9

(51) Int. Cl. E05B 47/00

(52) U.S. Cl. CPC E05B 47/0001
USPC 70/278.1; 70/277

(57) ABSTRACT

An electronic locking device for a furniture lock, which locks a door or drawer and is operable by means of a rotary knob, comprises at least a release electronics and a solenoid, which are arranged on the outside of the respective furniture wall facing away from the space to be locked and by which a locking pin can be moved back and forth between an unlocking position and a locking position. In the locking position, the locking pin locks the rotary knob and, in the unlocking position, the rotary knob is rotatable.

### BACKGROUND

The present invention relates to an electronic locking device for a furniture lock, which locks a door or drawer and is operable by means of a rotary knob.

It is well known to lock furniture doors or drawers to prevent unauthorized opening. For this purpose, lockable rotary knobs are often used, which move a latch and which are locked in the locked position by means of a lock cylinder. The furniture door or drawer can then no longer be opened. For unlocking, a corresponding key has to be at hand. With a large number of pieces of furniture this becomes relatively cumbersome since a great number of keys must be kept at hand. Handling is correspondingly cumbersome. As a consequence, furniture is often left unlocked for reasons of laziness.

An electronically lockable furniture lock is known from DE 20 2010 001 810 U1, wherein the release electronics is arranged within the rotary knob. Due to the necessary power supply, the structural size of the rotary knob is relatively large so that installation is not always possible. It is also relatively easy to pry off the rotary knob. DE 20 2005 006 957 U1 (corresponds to WO 2006/114330 A2) also describes a rotary knob for a piece of furniture, where the outer cap is secured by means of a clamping ring. The clamping ring is easily removeable so that the lock can be opened relatively easily by an unauthorized person.

### SUMMARY

It is thus the object of the present invention to provide a furniture lock with an electronic locking device, which can also be retrofitted and which provides high security against unauthorized opening.

The object is achieved according to the present invention by the locking device comprising at least a release electronics and a solenoid, which is arranged on the outside of the respective furniture wall facing away from the space to be locked and by which a locking pin can be moved back and forth between an unlocking position and a locking position wherein, in the locking position, the locking pin locks the rotary knob and, in the unlocking position, the rotary knob is rotatable. This configuration has the advantage that the mechanical locking mechanism of the lock does not have to be modified at all. Rather, it is possible to mount the solenoid on the outside in such a way that the locking pin can lock the rotary knob. The rotary knob then only needs to have a corresponding recess or hole, in which the locking pin engages.

It is advantageous if at least the solenoid is arranged in a housing mounted on the outer surface of the furniture wall, having an aperture for the rotary knob covering at least part of the rotary knob's circumference in the installed position, and into which the locking pin protrudes in its locking position in order to lock the rotary knob. The housing thus covers at least the locking pin and the solenoid so that opening by the application of force is prevented.

According to a preferred embodiment of the invention, it is provided that at least the solenoid is arranged in a housing which is mounted on the outer surface of the furniture wall, having an aperture for the rotary knob, through which the rotary knob extends in the installed position and into which the locking pin protrudes in its locking position in order to lock the rotary knob. This has the advantage, on the one hand, that the solenoid and the locking pin are covered by the housing, and on the other hand that the housing forms a collar around the area between the rotary knob and the furniture wall. Forced opening of the lock is thus prevented or at least made difficult.

It is particularly advantageous that it is possible to retrofit the electronic locking device. The housing also has a pleasant outward appearance so that the look of the furniture, which may well be of superior quality, is not negatively affected. Cumbersome installation work is avoided.

According to the present invention it is provided that the locking pin, in its locking position, engages a recess or hole at least in the outer shell of the rotary knob. The existing rotary knob can either be provided with a recess when the housing is installed, or alternatively the rotary knob can be installed together with the housing. In this case, the rotary knob fits precisely, and without a large gap, into the associated recess or aperture.

It can be provided that the locking pin is held in the locking position by the force of a spring. This has the advantage that the lock can be locked in such a way that upon a subsequent rotary motion of the rotary knob, it automatically engages in the locking position. Any cumbersome alignment of the rotary knob with respect to the locking pin can thus be avoided.

It is advantageous if the release electronics has a power supply independent of mains electricity. The solenoid and the release electronics do not need a large amount of energy so that batteries can ensure an adequate operational life.

Herein, it is advantageous if at least the power supply is arranged on the inner surface of the furniture wall facing away from the housing. By these means, the housing present on the outer surface can have a relatively small and flat structure so that it does not interfere with operational or aesthetic considerations.

Basically the release electronics can drive the solenoid in any desired way. It can be provided that the release electronics comprises a key pad, by which an access code can be input in order to move the locking pin into the unlocking position. A key pad can have a very flat design, and it enables a great number of access codes to be entered.

However, it can also be provided that the release electronics comprises a biometric sensor to move the locking pin into the unlocking position upon detection of a registered finger print. This further enhances security since the authorized person has to be actually present.

Alternatively or additionally, the release electronics can comprise a transponder to move the locking pin into the unlocking position upon detection of a registered transponder signal. In this case, opening can be caused by holding a token or a chip card against the front of the lock.

In detail, the configuration can be such that the release electronics and the solenoid are mounted on a housing base adjacent to the furniture wall on which a housing cover is mountable, which can be connected with the housing base from the side facing the furniture wall, and in that the housing is held against the furniture wall from the inside by means of screws. By these means, in the installed position, the mounting screws or the housing screws are not accessible from the outside. Unauthorized opening is thus made even more difficult.

Furthermore, it is advantageous if the rotary knob comprises a lock cylinder in order to mechanically lock the rotary knob. By these means, the furniture lock is provided with two independent locking means so that two operations are necessary to open it. This can be desirable in a situation where it is necessary that the piece of furniture in question can only be opened in the presence of two people, such as a document or weapons locker.

For this purpose, it is advantageous if the rotary knob is lockable by the lock cylinder in a position in which the locking pin is aligned with the hole or recess in the rotary knob and can engage the latter. In this case, the locking operations can be performed independently of each other. In particular, when the locking pin can be moved into the locking position by means of a spring, the electronic locking device can be activated first. As the rotary knob is rotated into the locking position, the locking pin engages and provides for mechanical engagement with the lock cylinder.

### BRIEF DESCRIPTION OF THE DRAWING

The invention will be described in more detail in the following with reference to the schematic drawing.

FIG. 1 is a cross-sectional view of a furniture lock with an electronic locking device according to the invention, in the installed state.

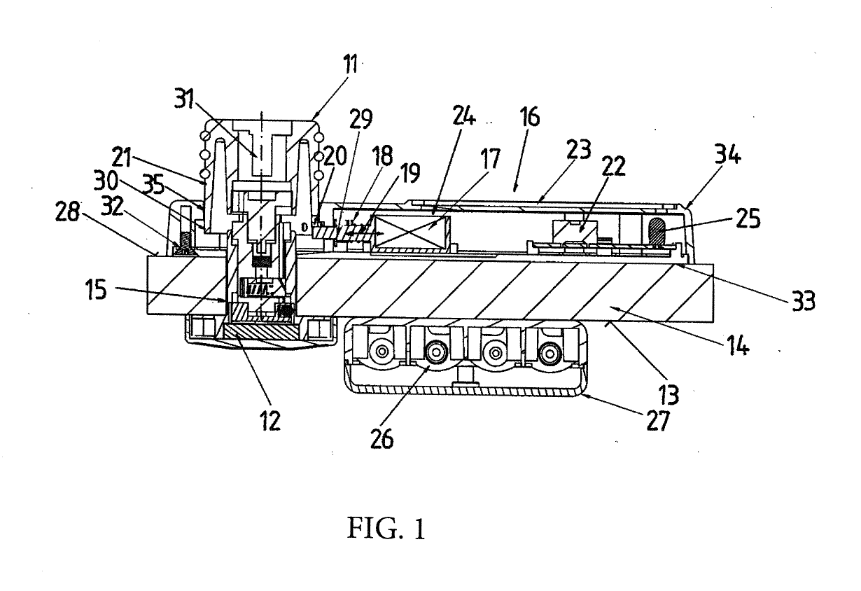

### DETAILED DESCRIPTION

The furniture lock shown in the drawing includes a rotary knob 11 for moving a latch 12 back and forth between locking and unlocking positions. The latch 12 moves in a direction normal to the drawing plane. The transmission for the latch and the latch itself are on the inside 13 of the furniture wall 14, such as a door panel or a drawer panel. The rotary knob is held in an aperture 15 in the furniture wall. The latch 12 is surrounded by a housing. Such furniture locks are known as such and need not be explained in any more detail.

An electronic locking device 16 is provided for locking the lock in its locking position. The locking device 16 includes a solenoid 17, by means of which a locking pin 18 can be moved back and forth between an unlocking position and a locking position, shown in the drawing, in the direction of double arrow 19 parallel to the furniture wall 14 and in a direction radial to the rotary axis of the rotary knob.

In the locking position, the locking pin 18 engages a recess 20 or hole in the outer shell 21 of the rotary knob 11 and locks it. In this situation, the rotary knob cannot be rotated and the lock cannot be opened any more. By moving the locking pin into the unlocking position, its free end moves out of engagement with the outer shell 21 so that the rotary knob is freely rotatable and the lock can be opened.

A release electronics 22, not shown in any further detail, is provided for driving the solenoid. The release electronics 22 includes a key pad 23, for example having the numbers 1, 2, . . . 10 and confirmation keys, such as # or * for inputting an access code. The key pad 23 is on the side of the housing 24 covering the locking device 16 which faces the operator so that it is easily accessible from the outside.

Furthermore, a light indicator such as a light emitting diode 25 can be provided which is visible on the outside in order to display operability, open position, closed position or an erroneous code. Operation of the keys of the key pad, or the open position or closed position of the locking pin, can also be acoustically indicated.

The release electronics 22 is provided with energy by means of a power supply independent of mains electricity. Batteries 26 may be provided, which are arranged in a battery housing 27 on the inside 13 of the furniture wall 14. By these means the housing 24 for the individual components of the electronic locking device 16 can have a flat configuration on the outside 28 of the furniture wall 14 and does not interfere with the operation of the rotary knob 11. Moreover, the battery housing 27 will not be visible from the outside.

The batteries can be connected to the release electronics 22 by means of an electric cable (not shown). The electric cable passes through an aperture in the furniture wall in an area covered by the housing 24. Cables are therefore not visible.

The locking pin 18 is held in its locking position by means of a spring 29, when the solenoid 17 is moved into the locking position. If the signal for locking is generated by the release electronics 22 while the locking pin 18 is not facing the recess and can therefore not enter it, it is pressed against the lower circumferential surface 30 adjacent to the wall and held there in a biased state. As soon as the recess 20 comes into alignment with the locking pin, the latter will engage the recess 20 and lock the rotary knob 11. The lock is securely locked.

The rotary knob 11 can also have a lock cylinder 31 for mechanically locking the lock. The construction is well known as such and therefore needs no further explanation. The configuration is chosen such that the lock can only be locked by the lock cylinder if the recess 20 is in alignment with the locking pin 18. By these means it can be achieved that the lock is locked by two locking operations in a simple manner.

The housing 24 has a base 33 which supports the release electronics. The base 33 is connected with the housing cover 34 by means of screws 32 in such a way that the screws are not accessible in the installed position. The base 33 has bores through which screws can extend from the inside 13 of the furniture wall 14 to threaded bores in the housing cover 34, to fixedly screw the latter to the furniture wall 14 from the inside 13. Screw heads will therefore not be accessible from the outside, and the housing 24 cannot be removed from the furniture wall 14. Only the keys of the key pad 23 are accessible from the side of access.

In the area of the aperture 15 in the furniture wall 14, the base 33 and the housing cover 34 have an aperture 35 into which the rotary knob fits at least with its circumferential portion 30 adjacent to the furniture wall 14. The locking pin 18 protrudes into this aperture in its locking position, so that it can engage the recess 20. The circumferential gap between the furniture wall 14 and the rotary knob 11 is thus completely surrounded by the housing 24 so that prizing off by the application of force is made difficult.

The electronic locking device 16 is thus in a housing which can be easily installed by removing the existing rotary knob and screw fastening the housing 24, in the desired orientation, over the aperture 15 provided in the furniture wall for the rotary knob shaft. A template can be provided with markings for the bores for the fixing screws and the bore for the electric cable. These are the only bores to be made. Then the housing 24 can be mounted in such a way that the aperture 35 in the housing is in alignment with the aperture 15. The housing 24 is screwed tight, and the battery housing 27 is installed. After connecting the electric cables and inserting the batteries, the electronic locking device is operational.

A new rotary knob 11 with a corresponding recess 20 in its outer shell 21 can be fixed in known manner to the shaft for operating the latch 12. However, the old rotary knob can also be provided with a recess thus enabling the old rotary knob to be used, which visually matches the other knobs on the piece of furniture.

The overall result is that the present electronic locking device can be easily installed on existing pieces of furniture. Only a few simple steps are needed to secure a closet door or a drawer against unauthorized opening.

I claim:

1. An electronic locking device for a furniture lock, which locks a door or drawer and is operable by means of a rotary knob (11), comprising:
release electronics (22); and
a solenoid (17) arranged on an outer surface (28) of a furniture wall (14) facing away from a space to be locked and by which a locking pin (18) is movable back and forth between an unlocking position and a locking position;
in the locking position, the locking pin (18) locks the rotary knob (11) and, in the unlocking position, the rotary knob (11) is rotatable.

2. The locking device according to claim 1, wherein at least the solenoid is arranged in a housing, which is mounted on the outer surface of the furniture wall and comprises an aperture for the rotary knob, which covers at least part of the rotary knob's circumference in an installed position, and into which the locking pin protrudes in its locking position in order to lock the rotary knob.

3. The locking device according to claim 1, wherein at least the solenoid (17) is arranged in a housing (24) which is mounted on the outer surface (28) of the furniture wall (14) and has an aperture (15) for the rotary knob (11), through which the rotary knob (11) extends in the installed position and into which the locking pin (18) protrudes in its locking position in order to lock the rotary knob (11).

4. The locking device according to 1, wherein the locking pin (18), in its locking position, engages a recess (20) or hole at least in an outer shell (21) of the rotary knob (11).

5. The locking device according to claim 1, wherein the locking pin (18) is held in the locking position by force of a spring (29).

6. The locking device according to claim 3, wherein the release electronics (22) has a power supply (26) independent of mains electricity.

7. The locking device according to claim 6, wherein at least the power supply (26) is arranged on an inside (13) of the furniture wall (14) facing away from the housing (24).

8. The locking device according to claim 1, wherein the release electronics (22) comprises a key pad (23) allowing an access code to be input for moving the locking pin (18) into the unlocking position.

9. The locking device according to claim 1, wherein the release electronics comprises a biometric sensor for moving the locking pin into the unlocking position upon detection of a registered finger print.

10. The locking device according to claim 1, wherein the release electronics comprises a transponder for moving the locking pin into the unlocking position upon detection of a registered transponder signal.

11. The locking device according to claim 1, wherein the release electronics (22) and the solenoid (17) are mounted on a housing base (33) adjacent to the furniture wall (14), on which housing base (33) a housing cover (34) is mountable, which can be connected with the housing base (33) from a side facing the furniture wall (14), and in that housing (24) is held against the furniture wall (14) from the inside (13) by means of screws.

12. The locking device according to claim 4, wherein the rotary knob (11) comprises a lock cylinder (31) for mechanically locking the rotary knob.

13. The locking device according to claim 12, wherein the rotary knob (11) is able to be locked by the lock cylinder (31) in a position in which the locking pin (18) is aligned with and can engage the recess (20) or hole in the rotary knob (11).
